(19) United States
(12) Patent Application Publication
(10) Pub. No.: US 2026/0339528 A1
(43) Pub. Date: Oct. 29, 2026

(54) MEMORY SYSTEMS AND OPERATING METHODS THEREOF, ELECTRONIC DEVICES, AND COMPUTER-READABLE STORAGE MEDIA

(71) Applicant: Yangtze Memory Technologies Co., Ltd., Wuhan (CN)

(72) Inventors: Tao Xiong, Wuhan (CN); Zhen Chen, Wuhan (CN)

(21) Appl. No.: 19/354,558

(22) Filed: Oct. 9, 2025

Related U.S. Application Data
(63) Continuation of application No. PCT/CN2025/090911, filed on Apr. 24, 2025.

(51) Int. Cl. G06F 3/06

(52) U.S. Cl. CPC G06F 3/0623; G06F 3/0652; G06F 3/0659; G06F 3/0679

(57) ABSTRACT

An example memory system includes: a memory device and a memory controller coupled to the memory device; the memory controller is configured to: receive a dataset management command, wherein the dataset management command includes a logical address range is to be trimmed and identification information, the identification information being configured to indicate whether to perform a security delete operation on the stored data corresponding to the logical address range; determine to perform a data overwrite operation on valid data in a stripe corresponding to the logical address range based on the identification information indicating that the security delete operation is to be performed on the stored data corresponding to the logical address range; and determine to perform programming operations on memory cells corresponding to physical addresses of the stripe corresponding to the logical address range.

### CROSS-REFERENCE TO RELATED APPLICATION

This patent arises from the national stage of International Patent Application No. PCT/CN 2025/090911, which was filed on May 8, 2025. International Application No. PCT/CN2025/090911 is hereby incorporated herein by reference in its entirety. Priority to International Application No. PCT/CN2025/090911 is hereby claimed.

### TECHNICAL FIELD

The present disclosure relates to the field of semiconductor technology, and relates to but is not limited to memory systems and operating methods thereof, electronic devices, and computer-readable storage media.

### BACKGROUND

With the rapid development of data storage technology, more and more data storage systems are appearing in electronic devices used by people, such as solid state drives (SSD) etc. SSDs have been widely used in the fields of military, automotive, industrial, medical, and aviation due to their characteristics of fast read and write speeds, vibration resistance, low power consumption, no noise, low heat and light weight etc.

### BRIEF DESCRIPTION OF THE DRAWINGS

FIG. 1 is a schematic diagram 1 of an example system with a memory system according to an example of the present disclosure.

FIG. 2 is a schematic diagram of an example memory card with a memory system according to an example of the present disclosure.

FIG. 3 is a schematic diagram of an example solid-state drive with a memory system according to an example of the present disclosure.

FIG. 4 is a schematic diagram of an example memory device comprising a peripheral circuit according to an example of the present disclosure.

FIG. 5 is a schematic diagram of an example memory comprising a memory array and a peripheral circuit according to an example of the present disclosure.

FIG. 6 is a schematic diagram 2 of an example system with a memory system according to an example of the present disclosure.

FIG. 7 is a schematic diagram of a memory system provided by an example of the present disclosure.

FIG. 8 is a schematic diagram of a plurality of sets provided by an example of the present disclosure.

FIG. 9 is a schematic diagram of extended physical addresses provided by an example of the present disclosure.

FIG. 10 is a schematic diagram of a processing of operating a memory system provided by an example of the present disclosure.

FIG. 11 is a flow chart of an operating method of a memory system provided by an example of the present disclosure.

FIG. 12 is another flow chart of an operating method of a memory system provided by an example of the present disclosure.

FIG. 13 is a schematic diagram of a computer-readable storage medium provided by an example of the present disclosure.

### DETAILED DESCRIPTION

Examples of the present disclosure will be described in more detail below with reference to the accompanying drawings. Although examples of the present disclosure are shown in the drawings, it should be understood that the present disclosure may be implemented in various ways and should not be limited to the DETAILED DESCRIPTION set forth herein. Rather, these examples are provided so that the present disclosure may be more thoroughly understood and the scope of the present disclosure may be fully conveyed to those skilled in the art.

In the following description, numerous specific details are given in order to provide a more thorough understanding of the present disclosure. It will be apparent, however, to one skilled in the art that the present disclosure may be practiced without one or more of these details. In other examples, some technical features well-known in the art are not described to avoid confusion with the present disclosure; that is, not all features of the actual example are described here, and well-known functions and structures are not described in detail.

In the accompanying drawings, the same reference numerals represent the same elements throughout.

It should be understood that, spatial relationship terms such as “under”, “below”, “beneath”, “underneath”, “on”, “above” and so on, may be used here for convenience to describe the relationship between one element or feature and other elements or features shown in the figures. It will be understood that the spatially relationship terms also comprise different orientations of the device in use and operation in addition to the orientation depicted in the figures. For example, if the device in the figures is turned over, elements or features described as “below” or “underneath” or “under” other elements or features would then be oriented as “above” the other elements or features. Thus, the example terms “below” and “under” can comprise both orientations of above and below. The device may be otherwise oriented (rotated 90 degrees or at other orientations) and the spatial description terms used herein may be interpreted accordingly.

The terminology used herein is for the purpose of describing particular examples only and is not to be taken as a limitation of the present disclosure. As used herein, “a”, “an” and “said/the” in singular forms are intended to include the plural forms as well, unless the context clearly dictates otherwise. It should also be understood that at least one of the terms “consist of” or “comprise”, when used in this specification, identify the presence of at least one of stated features, integers, operations, elements or components, but do not exclude presence or addition of at least one of one or more other features, integers, operations, elements, components or groups. As used herein, the term “at least one of . . . ” includes any and all combinations of the associated listed items.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

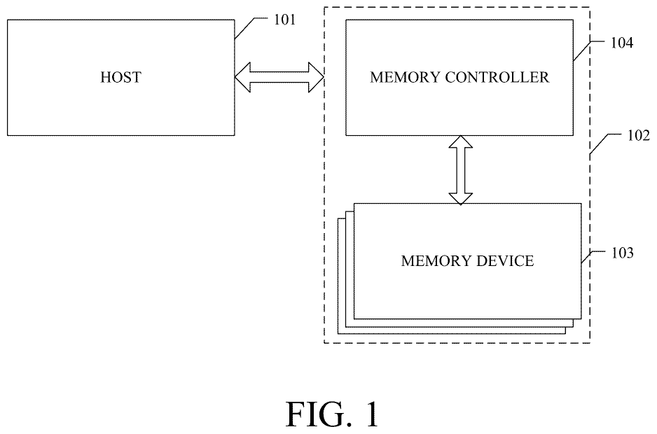

FIG. 1 is a schematic diagram of an example system with a memory system provided in an example of the present disclosure. In an example of the present disclosure, the system 100 may comprise a mobile phone, a desktop computer, a laptop, a tablet, a vehicle computer, a game console, a printer, a positioning device, a wearable electronic device, a smart sensor, a virtual reality (VR) device, an augmented reality (AR) device, or any other suitable electronic device having a memory therein. As shown in FIG. 1, the system 100 may comprise a host 101 and a memory system 102, wherein the memory system 102 may comprise one or more memory devices 103 and a memory controller 104. The host 101 may comprise a processor of an electronic device, such as a central processing unit (CPU), or a system on a chip (SoC), such as an application processor (AP). The host 101 may be configured to send data to the memory system 102 or receive data from the memory system 102.

In some examples, the memory controller 104 is coupled to the memory device 103 and the host 101, and is configured to control the memory device 103. The memory controller 104 can manage data stored in the memory device 103 and communicate with the host 101. In some examples, the memory controller 104 is designed to operate in a low duty cycle environment, such as in a secure digital card, a compact flash card (CFC), a universal serial bus (USB) flash drive, or in other media used in electronic devices such as personal computers, digital cameras, mobile phones, etc. In other examples, the memory controller 104 is designed to operate in a high duty cycle environment, such as a solid state drive or an embedded multimedia card (eMMC).

In some examples, the memory controller 104 and one or more memory devices 103 may be integrated into various types of storage devices, that is, the memory system 102 may be implemented and packaged into different types of end electronic products.

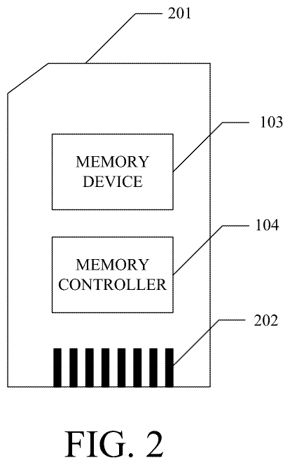

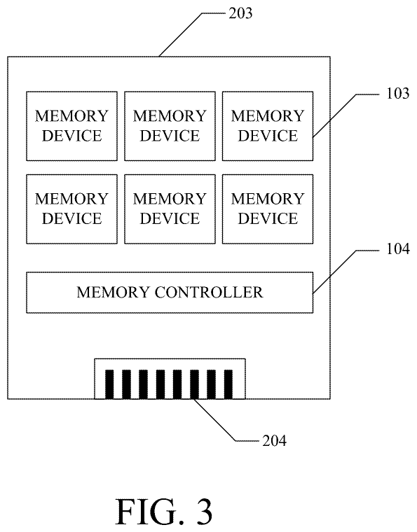

In an example as shown in FIG. 2, the memory controller 104 and a single memory device 103 may be integrated into a memory card 201. The memory card 201 may comprise a compact flash card, a smart media card (SMC), a memory stick (MS), a multimedia card (MMC), such as a reduced size MMC (RS-MMC), MMCmicro, eMMC, etc., a secure digital (SD) card, such as a Mini SD card, a Micro SD card, an SD high capacity (SDHC) card, etc., or a general flash card. The memory card 201 may also comprise a memory card connector 202 that couples the memory card 201 with a host-side device (e.g., the host 101 in FIG. 1). In another example as shown in FIG. 3, the memory controller 104 and a plurality of memory devices 103 may be integrated into an SSD 203. The SSD 203 may also comprise an SSD connector 204 that couples the SSD 203 with a host-side device (e.g., the host 101 in FIG. 1). In some examples, at least one of the storage capacity or operating speed of the SSD 203 is greater than that of the memory card 201.

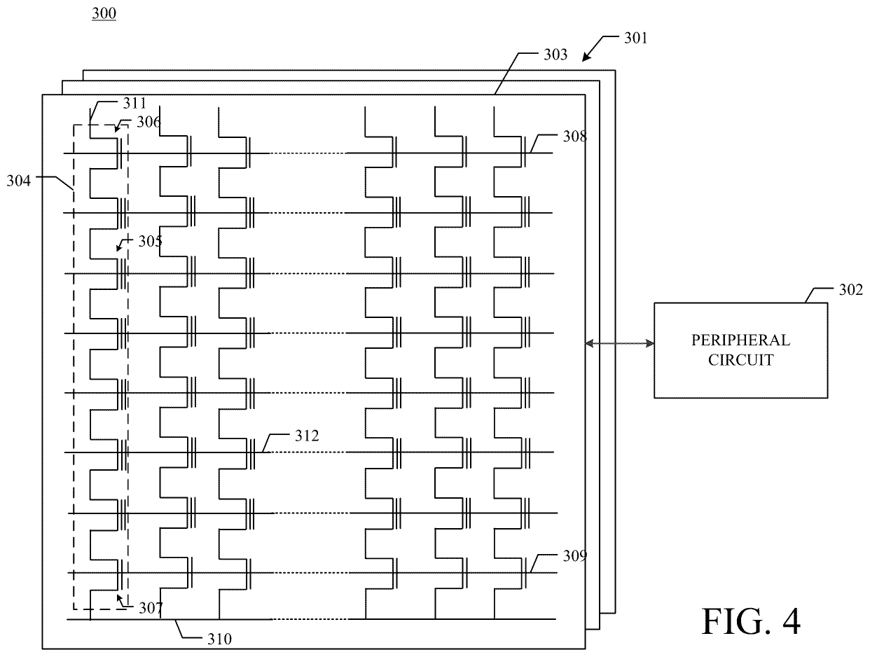

FIG. 4 is a circuit diagram of an example memory device 300 comprising a peripheral circuit as provided in an example of the present disclosure. The memory device 300 may be an example of the memory device 103 in FIG. 1. The memory device 300 may comprise a memory array 301 and a peripheral circuit 302 coupled to the memory array 301. The memory array 301 is taken as an example of a three-dimensional NAND type memory array for illustration, wherein the memory cell 305 is a NAND memory cell, and the memory cell 305 is provided in the form of an array of memory cell strings 304, wherein each memory cell string 304 extends vertically above a substrate (not shown). In some examples, each memory cell string 304 comprises a plurality of memory cells 305 coupled in series and stacked vertically. Each memory cell 305 may hold a continuous analog value, such as a voltage or charge, which depends on the number of electrons trapped in the region of the memory cell 305. Each memory cell 305 may be a floating gate type memory cell comprising a floating gate transistor, or a charge trap type memory cell comprising a charge trap transistor.

In some examples, each memory cell 305 is a single level cell (SLC) having two possible memory states and thus can store one bit of data. For example, the first memory state “0” can correspond to a first voltage range, and the second memory state “1” can correspond to a second voltage range. In some examples, each memory cell 305 is a multi-level cell capable of storing more than a single bit of data in four or more memory states, for example, a multi-level cell (MLC) storing two bits per cell, a triple level cell (TLC) storing three bits per cell, or a quad-level cell (QLC) storing four bits per cell.

As shown in FIG. 4, each memory cell string 304 can comprise a bottom select transistor (BST) 307 at its source end and a top select transistor (TST) 306 at its drain end. The bottom select transistor 307 and the top select transistor 306 may be configured to activate selected memory cell strings 304 during read and program operations. In some examples, the sources of the memory cell strings 304 in the same memory block 303 may be coupled via a common source line (Common Source Line, CSL) 310. In other words, all memory cell strings 304 in the same memory block 303 have an array common source (ACS). According to some examples, the top selection transistor 306 of each memory cell string 304 is coupled to a corresponding bit line (BL) 311, and data may be read from or written to the bit line 311 via an output bus (not shown). In some examples, each memory cell string 304 is configured to be selected or deselected by at least one of applying a select voltage (e.g., a voltage higher than a threshold voltage of the top select transistor 306) or a deselect voltage (e.g., 0V) to a top select gate (TSG) of the corresponding top select transistor 306 through one or more top select lines (TSL) 308 or applying a select voltage (e.g., a voltage higher than a threshold voltage of the bottom select transistor 307) or a deselect voltage (e.g., 0V) to a bottom select gate (BSG) of the corresponding bottom select transistor 307 through one or more bottom select lines (BSL) 309.

As shown in FIG. 4, the memory cell strings 304 may be organized into a plurality of memory blocks 303, each of which can have a common source line 310. In some examples, each memory block 303 is a basic data unit for an erase operation, e.g., all memory cells 305 on the same memory block 303 are erased at the same time. To erase the memory cells 305 in the selected memory block, a common source line 310 coupled to the selected memory block and unselected memory blocks in the same plane as the selected memory block may be biased with an erase voltage. It should be understood that in some examples, the erase operation may be performed at a half-memory block level, at a quarter-memory block level, or at a level having any suitable number of memory blocks or any suitable fractions of a memory block. The memory cells 305 of adjacent memory cell strings 304 may be coupled via word lines 312, which select which row of memory cells 305 is affected by read or program operations.

In some examples, the peripheral circuit 302 may comprise any suitable analog, digital, and mixed-signal circuits for enabling the operations of the memory array 301 by applying and sensing at least one of voltage signals or current signals to and from each target memory cell 305 through bit lines 311, word lines 312, common source lines 310, bottom select lines 309, and top select lines 308. The peripheral circuit 302 may comprise various types of peripheral circuits formed using metal-oxide-semiconductor technology.

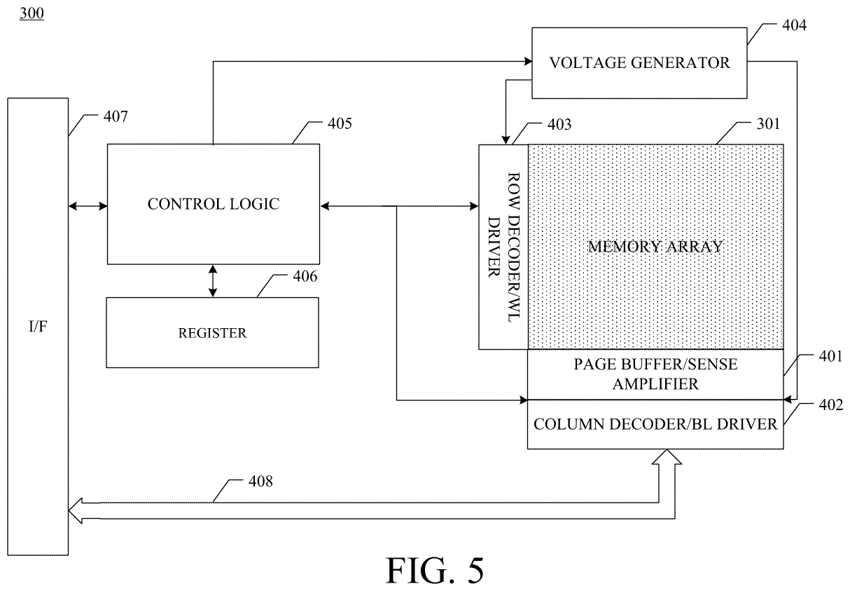

FIG. 5 shows some example peripheral circuits, and the peripheral circuit 302 comprises a page buffer/sense amplifier 401, a column decoder/bit line driver 402, a row decoder/word line driver 403, a voltage generator 404, a control logic 405, a register 406, a flash memory interface 407, and a data bus 408. It should be understood that in some examples, additional peripheral circuits not shown in FIG. 5 may also be comprised.

The page buffer/sense amplifier 401 may be configured to read data from the memory array 301 and program (write) data to the memory array 301 according to a control signal from the control logic 405. In one example, the page buffer/sense amplifier 401 can store a page of program data (write data) to be programmed into the memory array 301. In another example, the page buffer/sense amplifier 401 can perform a program verify operation to ensure that the data has been correctly programmed into the memory cells coupled to the selected word line. In yet another example, the page buffer/sense amplifier 401 can also sense the low power signals from the bit line that represent data bits stored in the memory cells and amplify the small voltage swing to recognizable logic levels in a read operation. The column decoder/bit line driver 402 may be configured to be controlled by the control logic 405 and select one or more memory cell strings by applying bit line voltages generated from the voltage generator 404.

The row decoder/word line driver 403 may be configured to be controlled by the control logic 405 and select/deselect memory blocks of the memory array 301 and select/deselect word lines of memory blocks. The row decoder/word line driver 403 may be further configured to drive word lines using word line voltages generated from the voltage generator 404. In some examples, the row decoder/word line driver 403 can also select/deselect and drive bottom select lines and top select lines as well. As described below in detail, the row decoder/word line driver 403 is configured to perform program operations on the memory cells coupled to the selected word line(s). The voltage generator 404 may be configured to be controlled by the control logic 405 and generate the word line voltages (e.g., read voltages, program voltages, pass voltages, local voltages, verification voltages, etc.), bit line voltages, and source line voltages to be supplied to the memory array 301.

The control logic 405 may be coupled to each peripheral circuit described above, and is configured to control the operation of each peripheral circuit. The register 406 may be coupled to the control logic 405, and includes a status register, a command register, and an address register for storing status information, a command operation code (OP code), and a command address for controlling the operation of each peripheral circuit. The flash memory interface 407 may be coupled to the control logic 405, and act as a control buffer to buffer control commands received from a host-side device (not shown) and relay them to the control logic 405, and to buffer status information received from the control logic 405 and relay them to the memory controller. The flash memory interface 407 may also be coupled to the column decoder/bit line driver 402 via the data bus 408, and act as a data input/output (I/O) interface and a data buffer to buffer data and relay them to the storage array 301 or relay or buffer data from the storage array 301.

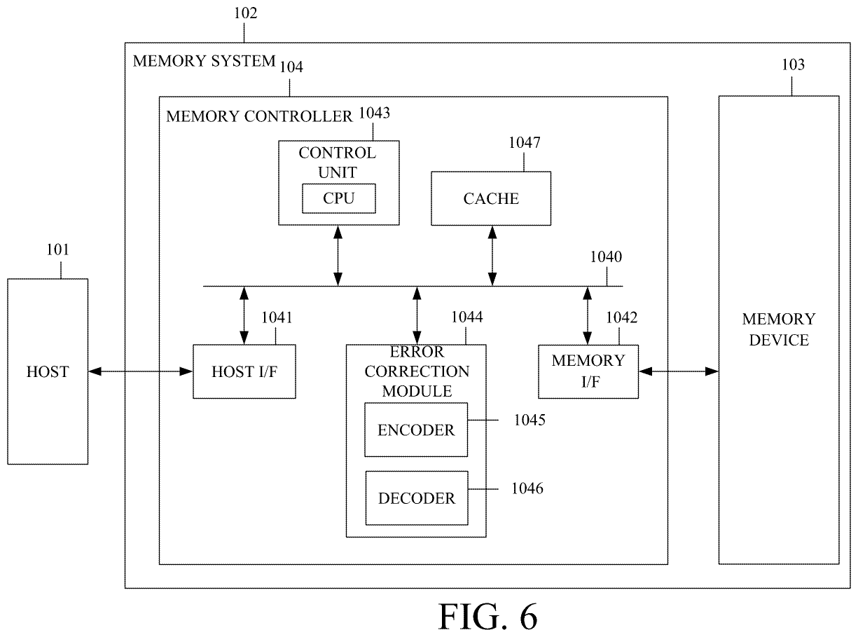

FIG. 6 is a schematic diagram of a system comprising a host and a memory system provided by an example of the present disclosure. As shown in FIG. 6, a memory system 102 is connected to a host 101, wherein the memory system 102 may comprise: a memory controller 104 and a memory device 103, wherein the memory controller 104 is configured to control the memory device 103 to perform operations such as read, write, and erase, and the memory controller 104 and the memory device 103 may also be coupled in any suitable manner. The memory controller 104 may comprise a host interface (I/F) 1041, a memory interface (I/F) 1042, a control unit 1043, an error correction module 1044, a cache 1047, and a bus 1040. Among them, the host interface 1041 may be a connection interface between the host 101 and the memory controller 104, and the host interface 1041 allows the host 101 and the memory controller 104 to communicate according to a specific protocol, send read and write requests, and perform other operations. The memory interface 1042 is a connection interface between the memory controller 104 and the memory device 103, and the memory interface 1042 is configured to enable data transmission between the memory controller 104 and the memory device 103. The control unit 1043 is configured to control the memory system 102 as a whole.

In some specific examples, the control unit 1043 may comprise one or more units with logical operation capabilities, such as at least one of a central processing unit (CPU) or a microcontroller unit (MCU) etc. The control unit 1043 may be responsible for executing firmware instructions and managing the operation of the memory system.

In some specific examples, the cache 1047 is configured to cache data, and may be a volatile memory device with a relatively fast read and write speed, such as at least one of a static random access memory (SRAM) or a dynamic random access memory (DRAM).

In some specific examples, the error correction module 1044 may be configured to encode and decode the data in the memory system using error correction code technology. Particularly, the error correction module 1044 may include an encoder 1045 and a decoder 1046, wherein the encoder 1045 may be configured to: encode the data to be written into the memory device in a write operation; the decoder 1046 may be configured to: decode the codeword to be decoded in the read data in a read operation.

With the widespread use of memory systems, users have saved a large amount of important data or private data (hereinafter collectively referred to as sensitive data) in the memory systems, such as important documents, private photos, and private videos. After using these sensitive data, users want to delete the data securely. Traditional delete operations cannot guarantee that the data will not be recovered by the adversary after being deleted. The goal of secure deletion is to ensure the security of the deleted data after deletion. In some examples, the data in the memory system may be securely deleted by using a data encryption technology with an independent key (Key per I/O) for each input/output operation. An independent encryption key is assigned to each input/output operation. When the data is to be deleted, the security of the sensitive data is improved by deleting the corresponding key. Since the data has been encrypted and the key is unrecoverable, the encrypted data will become “garbled code” that cannot be decrypted. Even if the key of the device is later leaked, the data after secure deletion cannot be restored.

Using an independent key for each input/output operation given in the above example requires the support of the Security Operations Center (SOC) to enhance monitoring, compliance and emergency response, and the software design is complex. In addition, the deletion solution of using an independent key for each input/output operation based on the namespace cannot achieve fine-grained secure deletion.

For this, the present disclosure proposes the following examples.

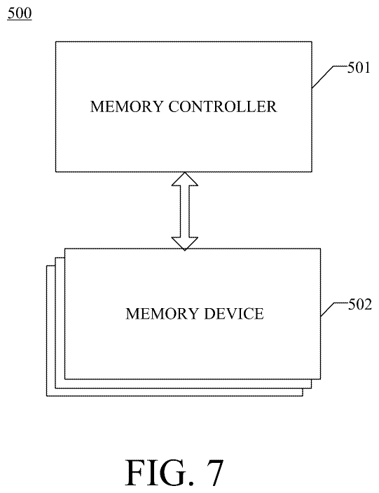

The present disclosure provides a memory system, as shown in FIG. 7, the memory system 500 includes: a memory device 502 and a memory controller 501 coupled to the memory device 502; the memory controller 501 is configured to: receive at least one dataset management command; wherein a logical address range to be trimmed and identification information are carried in the dataset management command, and the identification information is configured to indicate whether to perform a specific security delete operation on the stored data corresponding to the logical address range; determine to perform a data overwrite operation on valid data in the stripe corresponding to the logical address range based on the identification information indicating that a specific security delete operation is to be performed on the stored data corresponding to the logical address range; determine to perform programming operations on the memory cells corresponding to all physical addresses of the stripe corresponding to the logical address range.

In the disclosed examples, identification information is carried in the dataset management command, and the identification information may be configured to indicate whether to perform a specific security delete operation on the stored data corresponding to the logical address range. In case that the identification information indicates that a specific security delete operation is to be performed on the stored data corresponding to the logical address range, a data overwrite operation is performed on the valid data in the stripe corresponding to the logical address range, and programming operations are performed on the memory cells corresponding to all physical addresses of the stripe corresponding to the logical address range, thereby achieving fine-grained security deletion of the stored data corresponding to the specified logical address range, making the data irrecoverable after deletion, thereby ensuring the security of the information. The solution provided by the above example does not require the support of a security operation center and is easy to implement.

A dataset management command is an important instruction in the Non-Volatile Memory Express (NVMe) protocol for optimizing storage performance and managing data. The dataset management command may be configured to manage the dataset stored in the memory system 500, including allocating and releasing logical blocks. The dataset management command may implement operations on logical blocks by setting specific fields in a command. For example, by setting the Attribute-Deallocate (AD) field of Dword 11 to 1, the logical blocks in the specified range may be trimmed.

In the disclosed example, identification information is carried in the dataset management command, and the identification information, for example, may be jointly represented by a reserved field of a bit of double word 11 in the dataset management command and an attribute de-allocation field of Dword 11. In some examples, when a field corresponding to bit 03 of Dword 11 in the dataset management command (a field corresponding to bit 03 of Dword 11 in the dataset management command is originally a reserved field) is a third value, and the attribute de-allocation field of Dword 11 is 1, the identification information indicates that a specific security delete operation is to be performed on the stored data corresponding to the logical address range; when the field corresponding to bit 03 of Dword 11 in the dataset management command is a fourth value, and the attribute de-allocation field of Dword 11 is 1, the identification information indicates that a specific security delete operation is not to be performed on the stored data corresponding to the logical address range, but a logical block trim operation is to be performed on the stored data corresponding to the logical address range. The third value here may be 0, and the fourth value may be 1; or, the third value may be 1, and the fourth value may be 0.

In some examples, the memory controller 501 is configured to unmap the mapping relationships between the logical addresses corresponding to the logical address range and the corresponding physical addresses based on the identification information indicating that a specific security delete operation is not to be performed on the stored data corresponding to the logical address range.

It may be understood that when the identification information carried in the dataset management command indicates that a specific security delete operation is not to be performed on the stored data corresponding to the logical address range, the specific security delete operation may not be performed on the stored data corresponding to the logical address range, and the memory controller is configured to mark the logical address corresponding to the logical address range as unused, and a table of the mapping relationships between the logical addresses and the physical addresses may be updated to unmap the mapping relationships between logical addresses corresponding to the logical address range and corresponding physical addresses, so as to perform a logical block trim operation on the stored data corresponding to the logical address range, thereby trimming the logical addresses of the logical address range. A garbage collection operation is performed on the data stored in the memory cells corresponding to the logical address range, and after the garbage collection operation, respective logical addresses corresponding to the logical address range may be marked as reusable, and the physical addresses corresponding to the data stored in the memory cells corresponding to the logical address range may be marked as reusable.

In the example of the present disclosure, a logical address range to be trimmed is carried in the dataset management command, and the logical address range generally includes a starting logical address and a length of the logical address range.

In the disclosed example, the memory controller 501 determines to perform a data overwrite operation on the valid data in the stripe corresponding to the logical address range based on the identification information indicating that a specific security delete operation is to be performed on the stored data corresponding to the logical address range. The valid data here may be understood as data referenced by a mapping relationship table (such as L2P Table) between logical addresses and physical addresses. Before the memory controller 501 determines to perform a data overwrite operation on the valid data in the stripe corresponding to the logical address range based on the identification information indicating that a specific security delete operation is to be performed on the stored data corresponding to the logical address range, the mapping relationship between the logical address carried in the dataset management command that is to be trimmed and the corresponding physical address is unmapped. The valid data here does not include the stored data corresponding to the logical address range carried in the dataset management command that is to be trimmed. The valid data in the stripe corresponding to the logical address range carried in the dataset management command may be overwritten to other free stripes. In a process of performing the data overwrite operation on the valid data in the stripe corresponding to the logical address range, the programming operations are performed on the memory cells corresponding to all physical addresses of the stripe corresponding to the logical address range, thereby damaging the stored data corresponding to the logical address range carried in the dataset management command that is to be trimmed, so as to achieve the purpose of specific security deletion of the stored data corresponding to the logical address range, so that the stored data corresponding to the logical address range may not be restored. In the example of the present disclosure, the object on which the specific security delete operation is performed is the stored data corresponding to the logical address range carried in the dataset management command. The logical address range may include fewer logical addresses according to the needs, so that fine-grained data security deletion may be achieved.

In some examples, a table of mapping relationships between logical addresses and physical addresses may be stored in a cache 1047 as shown in FIG. 6.

In some examples, the memory controller 501 is configured to: obtain the logical address corresponding to the logical address range according to the logical address range to be trimmed carried in the dataset management command based on the identification information indicating that a specific security delete operation is to be performed on the stored data corresponding to the logical address range, and then obtain the corresponding physical address according to the corresponding logical address and the mapping relationship between the logical address and the physical address, and obtain all physical addresses of the stripe corresponding to the physical address according to the corresponding physical address. After obtaining all physical addresses of the stripe corresponding to the physical address, the memory controller 501 is configured to: determine to perform data overwrite operations on the valid data at all physical addresses of the stripe corresponding to the physical address; and determine to perform programming operations on the memory cells corresponding to all physical addresses of the stripe corresponding to the physical address.

In some examples, the memory controller 501 is configured to: after obtaining the corresponding physical address according to the corresponding logical address and the mapping relationship between the logical address and the physical address, unmap the mapping relationship between the physical address and the corresponding logical address, so that the logical address corresponding to the physical address is trimmed; in the process of performing a data overwrite operation on the valid data in the stripe corresponding to the logical address range, update the mapping relationships between logical addresses corresponding to the valid data and physical addresses.

The following will further describe how the memory controller performs data security deletion when receiving a plurality of dataset management commands that carry identification information indicating that a specific security delete operation is to be performed on the stored data corresponding to the carried logical address range.

In some examples, the memory controller 501 is configured to: receive a plurality of dataset management commands; perform command aggregation on dataset management commands in which identification information indicating that a specific security delete operation is to be performed on the stored data corresponding to the carried logical address range is carried in the plurality of the dataset management commands based on identification information carried in the plurality of the dataset management commands, to form a first set; determine to perform data overwrite operations on the valid data in respective stripes corresponding to the plurality of the logical address ranges based on respective logical address ranges carried in all the dataset management commands in the first set; determine to perform programming operations on the memory cells corresponding to all physical addresses of respective stripes corresponding to the plurality of the logical address ranges.

It may be understood that, in case of receiving a plurality of dataset management commands, the memory controller 501 may aggregate the dataset management commands in which identification information indicating that a specific security delete operation is to be performed on the stored data corresponding to the carried logical address range is carried, aggregate the plurality of dataset management commands in which identification information indicating that a specific security delete operation is to be performed on the stored data corresponding to the carried logical address range is carried to the first set, jointly perform data overwrite operations on the valid data in respective stripes corresponding to respective logical address ranges carried in all the dataset management commands in the first set, and jointly perform programming operations on the memory cells corresponding to all the physical addresses of respective stripes corresponding to respective logical address ranges carried in all the dataset management commands in the first set, so as to improve the execution efficiency. Here, jointly may be understood as being performed one by one in the same time period.

In some examples, the memory controller 501 is configured to: obtain respective logical address range carried in the dataset management commands in the first set based on the first set, to form a second set; obtain respective logical addresses corresponding to the plurality of the logical address ranges in the second set based on the second set, to form a third set; determine the physical addresses corresponding to respective logical addresses in the third set based on the third set and a table of mapping relationships between logical addresses and physical addresses, to form a fourth set; determine all physical addresses of stripes corresponding to respective physical addresses in the fourth set based on the fourth set, to form a fifth set.

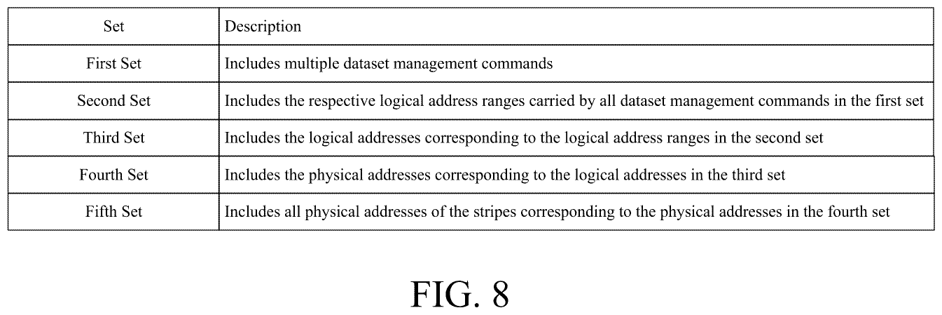

As shown in FIG. 8, the first set includes a plurality of dataset management commands, and each of identification information carried in the plurality of dataset management commands indicates that a specific security delete operation is to be performed on the stored data corresponding to the carried logical address range; the second set includes respective logical address ranges carried in all the dataset management commands in the first set; the third set includes respective logical addresses corresponding to a plurality of the logical address ranges in the second set, and the logical addresses contained in respective logical address ranges may be parsed according to the starting logical addresses of respective logical address ranges and the lengths of respective logical address ranges; the fourth set includes the physical addresses corresponding to respective logical addresses in the third set, and the physical addresses corresponding to respective logical addresses in the third set may be obtained according to the mapping relationships between the logical addresses and the physical addresses; the fifth set includes all physical addresses of stripes corresponding to respective physical addresses in the fourth set.

Redundant Array of Independent Disks (RAID) is a technology that combines a plurality of dies into a virtual memory device, and may achieve data redundancy and performance improvement through data striping and parity. For example, a physical address may mark each 4 k (e.g., each 4096^{th} physical address) on the memory device 502. A stripe in RAID includes a series of 4 k (e.g., 4096) physical addresses, and the data on these 4 k physical addresses are XORed with each other to get 0.

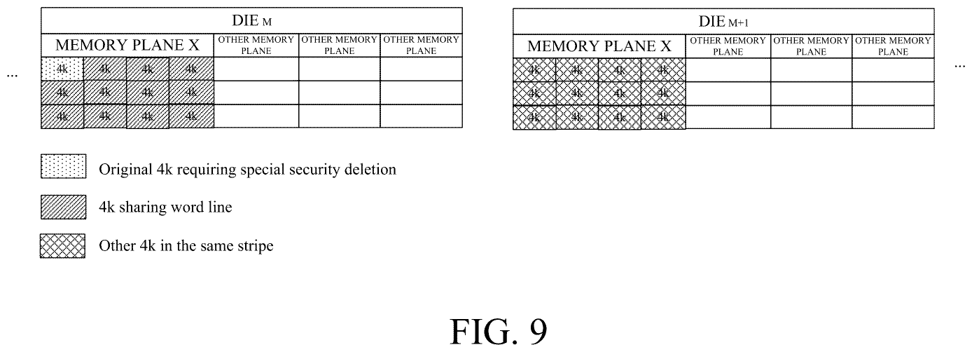

As shown in FIG. 9, the memory device 502 includes a plurality of dies, each of which includes a plurality of storage planes. The 4 k which a specific security deletion is originally required for may be understood as the physical address corresponding to the logical address range to be trimmed and carried in the dataset management command. The physical addresses corresponding to the logical address range may correspond to the 4 k capacity in the die M. All physical addresses of the stripe corresponding to the physical address corresponding to the logical address range may include the physical address corresponding to the 4 k which a specific security deletion is originally required for, the physical addresses corresponding to other 4 k on the die M that shares the word line for the 4 k corresponding to the logical address range, and the physical addresses corresponding to other 4 k in the same stripe.

In some examples, the memory controller 501 is configured to: determine to perform data overwrite operations on valid data at respective physical addresses in the fifth set based on the fifth set; determine to perform programming operations on memory cells corresponding to all physical addresses in the fifth set based on the fifth set.

It may be understood that after obtaining the fifth set, the data overwrite operations may be jointly performed on the valid data at respective physical addresses in the fifth set, and the programming operation may be jointly performed on the memory cells corresponding to all physical addresses in the fifth set, so that the execution efficiency may be improved. Here, jointly may be understood as being performed one by one in the same time period.

In some examples, the memory controller 501 is configured to: after forming the fourth set, unmap the mapping relationships between respective physical addresses in the fourth set and the corresponding logical addresses.

It may be understood that after forming the fourth set, the memory controller configured to mark the logical addresses corresponding to respective physical addresses in the fourth set (that is, the logical addresses in the third set) as unused, and may update the table of mapping relationships between the logical addresses and the physical addresses, and unmap the mapping relationships between the physical addresses in the fourth set and the corresponding logical addresses, so that the logical addresses corresponding to respective physical addresses in the fourth set are trimmed. After the mapping relationships between the physical addresses in the fourth set and the corresponding logical addresses are trimmed, the stored data corresponding to the respective physical addresses in the fourth set is invalid data, then overwrite operations are not to be performed on the stored data corresponding to respective physical addresses in the fourth set in subsequent overwrite operations.

In some examples, after performing programming operations on the memory cells corresponding to all physical addresses in the fifth set, a garbage collection operation may be performed on the data stored in the memory cells corresponding to all physical addresses in the fifth set. After the garbage collection operation, respective logical addresses in the third set may be marked as reusable, and all physical addresses in the fifth set may be marked as reusable.

In some examples, the memory controller 501 is configured to update the mapping relationships between the logical addresses corresponding to the valid data and the physical addresses during a process of performing data overwrite operations on the valid data in respective stripes corresponding to the plurality of the logical address ranges.

It may be understood that valid data in respective stripes corresponding to the plurality of the logical address ranges may be overwritten to other free stripes, and in a process of performing the overwrite operation on the valid data, the mapping relationship between the logical address corresponding to the valid data and the physical address is to be updated. In some examples: in a process of performing the data overwrite operations on the valid data in respective stripes corresponding to the plurality of the logical address ranges, the logical addresses corresponding to the valid data remain unchanged, and free physical addresses for the valid data are to be reallocated, and the mapping relationships between the physical addresses corresponding to the valid data in all the physical addresses in the fifth set and the corresponding logical addresses may be released, and then mapping relationships between the logical addresses corresponding to the valid data and the physical addresses reallocated for the valid data may be established, so that the mapping relationships between the logical addresses corresponding to the valid data and the physical addresses may be updated, and when the read operation is performed on the valid data later, the corresponding valid data may be read according to the updated mapping relationships between the logical addresses corresponding to the valid data and the physical addresses.

In some examples, the process of performing data overwrite operations on valid data in respective stripes corresponding to the plurality of the logical address ranges may include: the memory controller 501 may first read the valid data in respective stripes corresponding to the plurality of the logical address ranges from the memory device 502, and the memory controller 501 reallocates free physical addresses for the valid data, and then the memory controller 501 sends a overwrite operation command to the peripheral circuit of the memory device 502. The overwrite operation command may carry the data to be overwritten (that is, the valid data in respective stripes corresponding to the plurality of the logical address ranges read from the memory device) and the free physical addresses reallocated for the valid data, and the peripheral circuit writes the valid data to be overwritten into the positions corresponding to the reallocated free physical addresses.

In some examples, the dataset management commands in the first set are sorted in an order of receiving time, and the time interval for receiving adjacent dataset management commands in the first set is less than a predetermined time; the memory controller 501 is configured to: begin to obtain respective logical address range carried in all the dataset management commands in the first set based on the first set, to form a second set, based on no dataset management command carrying identification information indicating that a specific security delete operation is to be performed on the stored data corresponding to the carried logical address range has not been received again within a predetermined time after receiving a last dataset management command in the first set.

It may be understood that in case that the data management commands in the first set are sorted from the earliest to the latest according to the time of receipt, the time for receiving adjacent dataset management commands is less than the predetermined time, that is, the time interval for receiving adjacent dataset management commands is small. After the predetermined time of receiving a last dataset management command arranged in the first set, if no other dataset management command is received in which identification information indicating that a specific security delete operation is to be performed on the stored data corresponding to the carried logical address range is carried, a formal specific security delete operation is triggered. This can avoid a long waiting time and thus improve efficiency.

In some examples, the first set may also include only a dataset management command. For example, if within a predetermined time after receiving the first dataset management command in which identification information indicating that a specific security delete operation is to be performed on the stored data corresponding to the carried logical address range is carried, no dataset management command in which identification information indicating that a specific security delete operation is to be performed on the stored data corresponding to the carried logical address range is carried has not been received again, then there is only one dataset management command in the first set.

In some examples, the predetermined time ranges from 2 seconds(s) to 3 s.

It should be noted that the range of predetermined time given in the above examples is only an example and is not configured to limit the range of predetermined time in the examples of the present disclosure. For example, the predetermined time may be set according to the average time interval for receiving adjacent dataset management commands in which identification information indicating that a specific security delete operation is to be performed on stored data corresponding to the carried logical address range is carried in actual applications.

In some examples, the memory controller 501 is configured to: aggregate the dataset management commands received within a specific time period and carrying identification information indicating the a specific security delete operation is to be performed on the stored data corresponding to the carried logical address range to form a sixth set; wherein the specific time period includes: the time between beginning to obtain respective logical address range carried in all the dataset management commands in the first set based on the first set, to form a second set, and completion of the programming operation on the memory cells corresponding to all physical addresses in the fifth set.

In the disclosed example, beginning to obtain respective logical address ranges carried in all the dataset management commands in the first set based on the first set, to form a second set means that the specific security delete operation is began to be performed on the stored data corresponding to the logical address range to be trimmed carried in the data management commands in the first set; completion of performing the programming operation on the memory cells corresponding to all physical addresses in the fifth set means that the execution of the specific security delete operation on the stored data corresponding to the logical address range to be trimmed carried in the data management commands in the first set is completed. During the execution of the specific security delete operation on the stored data corresponding to the logical address range to be trimmed carried in the data management commands in the first set, the received other dataset management commands in which identification information indicating that the specific security delete operation is to be performed on the stored data corresponding to the carried logical address range is carried are aggregated in the sixth set. After the completion of performing the specific security delete operations on the stored data corresponding to the logical address ranges to be trimmed carried in the data management commands in the first set, specific security delete operations are performed on the stored data corresponding to the logical address ranges to be trimmed carried in the data management commands in the sixth set.

In some examples, the memory controller 501 is configured to set the value of the specific security deletion count to a first value based on a dataset management command in which identification information indicating that a specific security delete operation is to be performed on the stored data corresponding to the carried logical address range has not been received again within a predetermined time after receiving a last dataset management command in the first set.

In some examples, the memory controller 501 is configured to update the value of the specific security deletion count to a second value based on completion of performing programming operations on the memory cells corresponding to all physical addresses in the fifth set.

It may be understood that, if, no dataset management command carrying identification information indicating that a specific security delete operation is to be performed on the stored data corresponding to the carried logical address range has been received again within a predetermined time after receiving a last dataset management command in the first set, a formal specific security delete operation is to be triggered, and the value of the specific security deletion count being set to the first value may indicate that the specific security delete operation is being performed; the completion of performing programming operations on the memory cells corresponding to all physical addresses in the fifth set may indicate that the specific security delete operation has been completed, thereby the value of the specific security deletion count may be updated to the second value.

In some examples, the first value is 0 and the second value is 1; or, the first value is 1 and the second value is 0. This disclosure does not limit this.

In some examples, the value of the specific security deletion count may be stored in a cache 1047 in a memory controller as shown in FIG. 6.

In some examples, the memory controller 501 is configured to: receive a vendor-specific command; in response to the vendor-specific command, send a current value of the specific security deletion count.

The memory controller 501 can receive a vendor-specific command sent by the host, and the vendor-specific command indicates to obtain the current specific security deletion status. In case of receiving the vendor-specific command, the memory controller 501 sends a current value of the specific security deletion count to the host in response to the vendor-specific command. If the current value of the specific security deletion count is the first value, it indicates that the current specific security delete operation is being performed. If the current value of the specific security deletion count is the second value, it means that the current specific security delete operation has been completed. In some examples, the interface for obtaining the security deletion status may use the vendor-specific command framework, the interface for getting the release group count (Get Trim Group Count), and the additional 32 bits to represent the security deletion count.

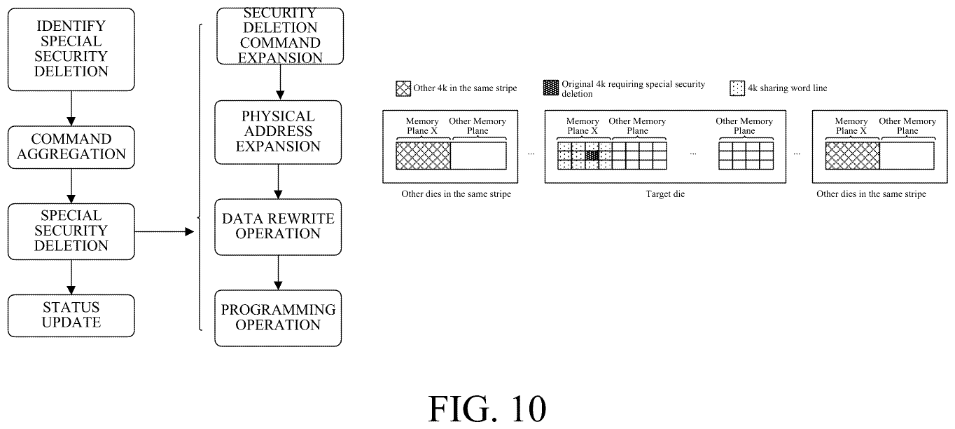

As shown in FIG. 10, after receiving a dataset management command, the memory controller 501 may identify whether a specific security deletion is required according to the identification information carried in the dataset management command. After identification, the dataset management commands in which identification information indicating that a specific security delete operation is to be performed on the stored data corresponding to the carried logical address range is carried in a plurality of dataset management commands are aggregated to form a first set, thereby triggering specific security deletion, and the value of the specific security deletion count may be set to a first value. The specific security deletion includes: security deletion command expansion, physical address extension, data overwrite operation, and programming operation. Security deletion command expansion may include: recording the logical address ranges carried in all dataset management commands in the first set into the second set to obtain a set of logical address ranges; parsing all logical address ranges in the second set one by one to obtain corresponding logical addresses, and recording the corresponding logical addresses in the third set, the third set contains all logical addresses to be trimmed; for all logical addresses in the third set, retrieving their corresponding physical addresses and recording corresponding physical addresses in the fourth set. The physical address extension includes: for all physical addresses in the fourth set, calculating their extended physical addresses one by one, and recording all physical addresses in the fourth set and the extended physical addresses into the fifth set, and the physical addresses in the fourth set include the physical addresses corresponding to the 4 k in the target die for which a specific safety deletion is originally required as shown in FIG. 10. The calculation method of the extended physical address includes two dimensions: the first one, the shared word line dimension, including other 3 of 4 k in the same physical page, and all 4 k in the other shared logical page (LP/MP/UP), such as the physical addresses corresponding to the other 4 k in the target die that share the word line with the 4 k for which a specific safety deletion is originally required as shown in FIG. 10; the second one, the independent disk redundant array dimension, including all 4 k in the same stripe at the shared physical page level, such as the physical addresses corresponding to the other 4 k in the same stripe in other dies as shown in FIG. 10. The data overwrite operation includes performing data overwrite operations on valid data stored in valid physical addresses in the fifth set. The programming operation includes performing programming operations on the memory cells corresponding to all physical addresses in the fifth set. As shown in FIG. 10, after the specific safety deletion is completed, the state may be updated by updating the value of the specific safety deletion count.

In some specific examples, the memory controller 501 may also include a read -only memory (ROM), which may be configured to store firmware code required when the memory system 500 is started. The memory controller 501 may also include a tightly coupled memory (TCM), a high-speed cache for storing temporary data and instructions to speed up the processing process. The memory controller 501 may also include an accelerator for accelerating the processing of specific tasks, such as data encryption, compression, etc.

The above process in the example of the present disclosure may be integrated into the firmware code of the memory system 500 and stored in the memory device 502. The memory device 502 may be a non-volatile memory device running in a tightly coupled memory or cache of the memory controller 501.

In some examples, memory system 500 comprises a solid state drive or a memory card. Memory device 502 comprises a three-dimensional NAND type memory device.

An example of the present disclosure further provides an electronic device, including: a memory system as in any of the above examples and a host coupled to the memory system based on the above memory system.

In the above example, the electronic device may be the system 100 as shown in FIG. 1, and the structure and composition of the memory system may refer to the detailed description of FIG. 1 to FIG. 6. The memory device here may be the memory device as shown in FIG. 1 to FIG. 6, and the memory controller here may be the memory controller as shown in FIG. 1, FIG. 2, FIG. 3 and FIG. 6. For the sake of brevity, they will not be described in detail.

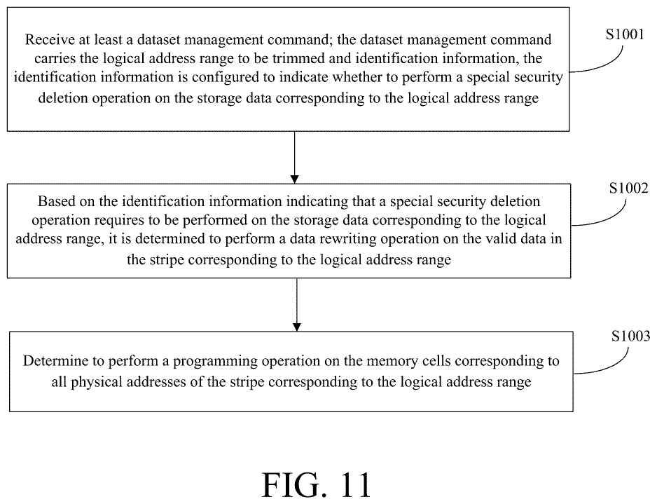

Based on the above-mentioned memory system, an example of the present disclosure also provides an operating method of the memory system, as shown in FIG. 11, the operating method of the memory system includes: operation S1001: receiving at least one dataset management command; a logical address range to be trimmed and identification information are carried in the dataset management command, and the identification information is configured to indicate whether to perform a specific security delete operation on stored data corresponding to the logical address range; operation S1002: determining to perform a data overwrite operation on valid data in the stripe corresponding to the logical address range based on the identification information indicating that a specific security delete operation is to be performed on the stored data corresponding to the logical address range; operation S1003: determining to perform programming operations on the memory cells corresponding to all physical addresses of the stripe corresponding to the logical address range.

In some examples, receiving at least one dataset management command includes: receiving a plurality of dataset management commands; the operating method also includes: performing command aggregation on dataset management commands in which identification information indicating that a specific security delete operation is to be performed on the stored data corresponding to the carried logical address range is carried in the plurality of the dataset management commands based on identification information carried in the plurality of the dataset management commands, to form a first set; determining to perform a data overwrite operation on the valid data in the stripe corresponding to the logical address range based on the identification information indicating that a specific security delete operation is to be performed on the stored data corresponding to the logical address range, including: determining to perform data overwrite operations on the valid data in respective stripes corresponding to the plurality of the logical address ranges based on respective logical address ranges carried in all the dataset management commands in the first set; determining to perform programming operations on the memory cells corresponding to all physical addresses of the stripe corresponding to the logical address range, including: determining to perform programming operations on the memory cells corresponding to all physical addresses of respective stripe corresponding to the plurality of the logical address ranges.

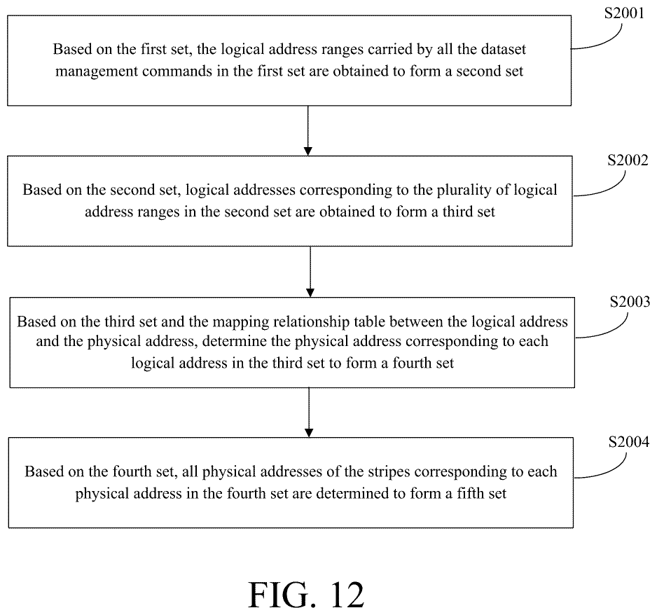

In some examples, as shown in FIG. 12, the operating method also includes: operation S2001: obtaining respective logical address range carried in all dataset management commands in the first set based on the first set, to form a second set; operation S2002: obtaining respective logical addresses corresponding to the plurality of the logical address ranges in the second set based on the second set, to form a third set; operation S2003: determining the physical addresses corresponding to respective logical addresses in the third set based on the third set and a table of the mapping relationships between logical addresses and physical addresses, to form a fourth set; operation S2004: determining all physical addresses of stripes corresponding to respective physical addresses in the fourth set based on the fourth set, to form a fifth set.

In some examples, determining to perform a data overwrite operation on valid data in a stripe corresponding to a logical address range includes: determining to perform data overwrite operations on valid data at respective physical addresses in the fifth set based on a fifth set; determining to perform programming operations on memory cells corresponding to all physical addresses of the stripe corresponding to the logical address range includes: determining to perform programming operations on memory cells corresponding to all physical addresses in the fifth set based on the fifth set.

In some examples, the operating method further includes: after forming the fourth set, unmapping the mapping relationships between respective physical addresses in the fourth set and the corresponding logical addresses.

In some examples, the operating method further includes: in a process of performing data overwrite operations on valid data in respective stripes corresponding to the plurality of the logical address ranges, updating mapping relationships between logical addresses corresponding to the valid data and physical addresses.

In some examples, the dataset management commands in the first set are sorted in an order of receiving time, and the time interval for receiving adjacent dataset management commands in the first set is less than a predetermined time; the operating method also includes: beginning to obtain respective logical address ranges carried in all dataset management commands in the first set based on the first set, to form a second set, based on the fact that no dataset management command carrying identification information indicating a specific security delete operation is to be performed on stored data corresponding to the carried logical address range has been received again within a predetermined time after receiving a last dataset management command in the first set.

In some examples, the predetermined time ranges from 2 s to 3 s.

In some examples, the operating method also includes: setting a value of a specific security deletion count to a first value based on the fact that no dataset management command carrying identification information indicating a specific security delete operation is to be performed on stored data corresponding to the carried logical address range has been received again within the predetermined time after receiving a last dataset management command in the first set.

In some examples, the operating method further includes: updating the value of the specific security deletion count to a second value based on completion of performing programming operations on memory cells corresponding to all physical addresses in the fifth set.

In some examples, the operating method further includes: receiving a vendor-specific command; in response to the vendor-specific command, sending a current value of the specific security deletion count.

In some examples, the operating method also includes: aggregating dataset management commands received within a specific time period and carrying identification information indicating a specific security delete operation is to be performed on stored data corresponding to the carried logical address range to form a sixth set; wherein the specific time period includes: time between beginning of obtaining respective logical address ranges carried in all the dataset management commands in the first set based on the first set to form the second set, and completion of performing programming operations on memory cells corresponding to all physical addresses in the fifth set.

In some examples, the operating method further includes: unmapping mapping relationships between logical addresses corresponding to the logical address range and corresponding physical address based on the identification information indicating that a specific security delete operation is not to be performed on stored data corresponding to the logical address range.

The operating method of the memory system mentioned in the above example has been described in detail in the aforementioned example of the memory system, and will not be repeated here for the sake of brevity.

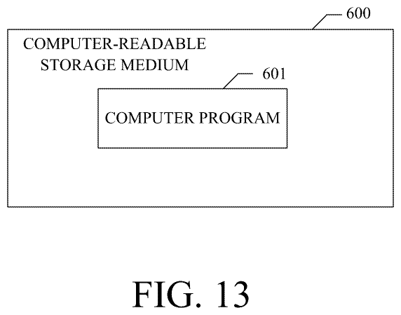

Based on the operating method of the above-mentioned memory system, as shown in FIG. 13, an example of the present disclosure further provides a computer-readable storage medium 600 having a computer program 601 stored thereon which, executed by a processor, performs an operating method of a memory system as in any of the above examples.

Here, all or part of the operating method of the memory system in the above example may be implemented by instructing the relevant hardware through a computer program, and the computer program may be stored in a computer-readable storage medium. When the program is executed, it may include the processes of the examples of the above methods. Among them, the storage medium may be a ferromagnetic random access memory (FRAM), a read-only memory (ROM), a programmable read-only memory (PROM), an erasable programmable read-only memory (EPROM), an electrically erasable programmable read-only memory (EEPROM), a flash memory, a magnetic surface memory, an optical disc or a compact disc read-only memory (CD-ROM), etc.; the storage medium can also include a combination of the above-mentioned types of memory.

The features disclosed in the several device examples provided in the present disclosure may be arbitrarily combined to obtain a new device example without conflict.

The methods disclosed in the several method examples provided in the present disclosure may be arbitrarily combined to obtain a new method example without conflict.

According to a first aspect of an example of the present disclosure, a memory system is provided, comprising: a memory device and a memory controller coupled to the memory device; the memory controller is configured to: receive at least one dataset management command; wherein a logical address range to be trimmed and identification information are carried in the dataset management command, the identification information is configured to indicate whether to perform a specific security delete operation on the stored data corresponding to the logical address range; determine to perform a data overwrite operation on valid data in a stripe corresponding to the logical address range, based on the identification information indicating that a specific security delete operation is to be performed on the stored data corresponding to the logical address range; determine to perform programming operations on memory cells corresponding to all physical addresses of the stripe corresponding to the logical address range.

In some examples, the memory controller is configured to: receive a plurality of the dataset management commands; perform command aggregation on dataset management commands in which identification information indicating that a specific security delete operation is to be performed on the stored data corresponding to the carried logical address range is carried in the plurality of the dataset management commands based on identification information carried in the plurality of the dataset management commands, to form a first set; determine to perform data overwrite operations on valid data in respective stripes corresponding to a plurality of the logical address ranges based on the respective logical address ranges carried in all the dataset management commands in the first set; determine to perform programming operations on memory cells corresponding to all physical addresses of respective stripes corresponding to the plurality of the logical address ranges.

In some examples, the memory controller is configured to: obtain respective logical address ranges carried in all the dataset management commands in the first set based on the first set, to form a second set; obtain respective logical addresses corresponding to the plurality of the logical address ranges in the second set based on the second set, to form a third set; determine physical addresses corresponding to respective logical addresses in the third set based on the third set and a table of mapping relationships between logical addresses and physical addresses, to form a fourth set; determine all physical addresses of the stripes corresponding to respective physical addresses in the fourth set based on the fourth set, to form a fifth set.

In some examples, the memory controller is configured to: determine to perform data overwrite operations on valid data at respective physical addresses in the fifth set based on the fifth set; determine to perform programming operations on memory cells corresponding to all physical addresses in the fifth set based on the fifth set.

In some examples, the memory controller is configured to: after forming the fourth set, unmap the mapping relationships between respective physical addresses in the fourth set and corresponding logical addresses.

In some examples, the memory controller is configured to: in the process of performing data overwrite operations on valid data in respective stripes corresponding to a plurality of the logical address ranges, update mapping relationships between the logical addresses corresponding to the valid data and physical addresses.

In some examples, the dataset management commands in the first set are sorted in an order of receiving time, the time interval for receiving adjacent dataset management commands in the first set is less than a predetermined time; the memory controller is configured to: begin to obtain respective logical address ranges carried in all dataset management commands in the first set based on the first set, to form a second set based on the fact that no dataset management command carrying identification information indicating a specific security delete operation is to be performed on the stored data corresponding to the carried logical address range has been received again within the predetermined time after receiving a last dataset management command in the first set.

In some examples, the predetermined time ranges from 2 s to 3 s.

In some examples, the memory controller is configured to: set the value of the specific security deletion count to a first value based on the fact that no dataset management command carrying identification information indicating a specific security delete operation is to be performed on the stored data corresponding to the carried logical address range has been received again within the predetermined time after receiving a last dataset management command in the first set.

In some examples, the memory controller is configured to: update the value of the specific security deletion count to a second value based on completion of the programming operations on the memory cells corresponding to all the physical addresses in the fifth set.

In some examples, the memory controller is configured to: receive a vendor-specific command; in response to the vendor-specific command, send a current value of the specific security deletion count.

In some examples, the memory controller is configured to: perform command aggregation on dataset management commands received within a specific time period and carrying identification information indicating that a specific security delete operation is to be performed on the stored data corresponding to the carried logical address range, to form a six set; the specific time period includes: the time between the beginning of obtaining the respective logical address ranges carried in all the dataset management commands in the first set based on the first set, to form the second set, and completion of the programming operations on the memory cells corresponding to all physical addresses in the fifth set.

In some examples, the memory controller is configured to: unmap the mapping relationship between the logical address corresponding to the logical address range and the corresponding physical address based on the identification information indicating that no specific security delete operation is to be performed on the stored data corresponding to the logical address range.

In some examples, the memory system includes a solid state drive or a memory card.

According to a second aspect of an example of the present disclosure, an electronic device is provided, comprising: a memory system as described in any one of the above examples and a host coupled to the memory system.

According to a third aspect of an example of the present disclosure, a method of operating a memory system is provided, comprising: receiving at least one dataset management command; wherein a logical address range to be trimmed and identification information are carried in the dataset management command, the identification information is configured to indicate whether to perform a specific security delete operation on the stored data corresponding to the logical address range; determining to perform a data overwrite operation on valid data in the stripe corresponding to the logical address range, based on the identification information indicating that a specific security delete operation is to be performed on the stored data corresponding to the logical address range; determining to perform programming operations on memory cells corresponding to all physical addresses of the stripe corresponding to the logical address range.

In some examples, receiving at least one dataset management command includes: receiving a plurality of dataset management commands; the operating method also includes: performing command aggregation on dataset management commands in which identification information indicating that a specific security delete operation is to be performed on the stored data corresponding to the carried logical address range is carried in the plurality of the dataset management commands based on identification information carried in the plurality of the dataset management commands, to form a first set; determining to perform a data overwrite operation on the valid data in the stripe corresponding to the logical address range, based on the identification information indicating that a specific security delete operation is to be performed on the stored data corresponding to the logical address range, includes: determining to perform data overwrite operations on valid data in respective stripes corresponding to a plurality of the logical address ranges based on the respective logical address ranges carried in all the dataset management commands in the first set; determining to perform programming operations on memory cells corresponding to all physical addresses of the stripe corresponding to the logical address range includes: determining to perform programming operations on memory cells corresponding to all physical addresses of respective stripes corresponding to the plurality of the logical address ranges.

In some examples, the operating method also includes: obtaining the respective logical address ranges carried in all the dataset management commands in the first set based on the first set, to form a second set; obtaining respective logical addresses corresponding to the plurality of the logical address ranges in the second set based on the second set, to form a third set; determining physical addresses corresponding to respective logical addresses in the third set based on the third set and a table of mapping relationships between logical addresses and physical addresses, to form a fourth set; determining all physical addresses of the stripes corresponding to respective physical addresses in the fourth set based on the fourth set, to form a fifth set.

In some examples, determining to perform a data overwrite operation on valid data in the stripe corresponding to the logical address range includes: determining to perform data overwrite operations on valid data at respective physical addresses in the fifth set based on the fifth set; determining to perform programming operations on memory cells corresponding to all physical addresses of the stripe corresponding to the logical address range includes: determining to perform programming operations on memory cells corresponding to all physical addresses in the fifth set based on the fifth set.

In some implementations, the operating method further includes: after forming the fourth set, unmapping the mapping relationships between respective physical addresses in the fourth set and corresponding logical addresses.

In some implementations, the operating method further includes: in the process of performing data overwrite operations on valid data in respective stripes corresponding to a plurality of the logical address ranges, updating mapping relationships between logical addresses corresponding to the valid data and physical addresses.

In some examples, the dataset management commands in the first set are sorted in an order of receiving time, the time interval for receiving adjacent dataset management commands in the first set is less than a predetermined time; the operating method also includes: beginning to obtain the respective logical address ranges carried in all dataset management commands in the first set based on the first set, to form a second set based on the fact that no dataset management command carrying identification information indicating a specific security delete operation is to be performed on the stored data corresponding to the carried logical address range has been received again within the predetermined time after receiving a last dataset management command in the first set.

In some examples, the predetermined time ranges from 2 s to 3 s.

In some examples, the operating method also includes: setting the value of the specific security deletion count to a first value based on the fact that no dataset management command carrying identification information indicating a specific security delete operation is to be performed on the stored data corresponding to the carried logical address range has been received again within the predetermined time after receiving a last dataset management command in the first set.

In some implementations, the operating method further includes: updating the value of the specific security deletion count to a second value based on completion of the programming operations on the memory cells corresponding to all the physical addresses in the fifth set.

In some implementations, the operating method further includes: receiving a vendor-specific command; in response to the vendor-specific command, sending a current value of the specific security deletion count.

In some examples, the operating method further includes: performing command aggregation on dataset management commands received within a specific time period and carrying identification information indicating that a specific security delete operation is to be performed on the stored data corresponding to the carried logical address range, to form a six set; the specific time period includes: the time between the beginning of obtaining the respective logical address ranges carried in all the dataset management commands in the first set based on the first set, to form the second set, and completion of the programming operations on the memory cells corresponding to all physical addresses in the fifth set.

In some examples, the operating method further includes: unmapping the mapping relationship between the logical address corresponding to the logical address range and the corresponding physical address based on the identification information indicating that no specific security delete operation is to be performed on the stored data corresponding to the logical address range.

According to a third aspect of an example of the present disclosure, a computer-readable storage medium is provided, the computer-readable storage medium having a computer program stored thereon, which, when executed by a processor, performs any one of example operating methods described above.

The above description is only a specific example of the present disclosure, but the protection scope of the present disclosure is not limited thereto. Any person skilled in the art can easily think of changes or substitutions within the technical scope disclosed in the present disclosure, which should be comprised in the protection scope of the present disclosure.

What is claimed is:

1. A memory system, comprising:
a memory device; and
a memory controller coupled to the memory device and configured to:
receive a dataset management command, wherein the dataset management command includes a logical address range to be trimmed and identification information, the identification information is configured to indicate whether to perform a security delete operation on stored data corresponding to the logical address range;
determine to perform a data overwrite operation on valid data in a stripe corresponding to the logical address range based on the identification information indicating that the security delete operation is to be performed on the stored data corresponding to the logical address range; and
determine to perform programming operations on memory cells corresponding to physical addresses of the stripe corresponding to the logical address range.

2. The memory system of claim 1, wherein the memory controller is configured to:
aggregate second dataset management commands to form a first set, the second dataset management commands including second identification information to indicate whether the security delete operation is to be performed on second stored data corresponding to second logical address ranges in the second dataset management commands;
determine to perform second data overwrite operations on second valid data in respective second stripes corresponding to the second logical address ranges in the second dataset management commands; and
determine to perform second programming operations on second memory cells corresponding to second physical addresses of respective ones of the second stripes corresponding to the second logical address ranges.

3. The memory system of claim 2, wherein the memory controller is configured to:
form a second set based on the second logical address ranges in the second dataset management commands;
form a third set based on second logical addresses corresponding to the second logical address ranges;
determine third physical addresses corresponding to respective third logical addresses in the third set based on a table of mapped logical-to-physical address relationships to form a fourth set; and
determine fifth physical addresses of third stripes corresponding to respective ones of fourth physical addresses in the fourth set to form a fifth set.

4. The memory system of claim 3, wherein the memory controller is configured to:
determine to perform third data overwrite operations on third valid data at respective ones of the fifth physical addresses in the fifth set; and
determine to perform third programming operations on third memory cells corresponding to the fifth physical addresses in the fifth set.

5. The memory system of claim 3, wherein the memory controller is configured to:
after forming the fourth set, unmap ones of the mapped logical-to-physical address relationships between ones of the third physical addresses in the fourth set and corresponding ones of the third logical addresses.

6. The memory system of claim 5, wherein the memory controller is configured to:
during a process of performing the second data overwrite operations on the second valid data in the second stripes corresponding to the second logical address ranges, update corresponding ones of the mapped logical-to-physical address relationships between ones of the second logical addresses corresponding to the second valid data and corresponding ones of the second physical addresses.

7. The memory system of claim 3, wherein the second dataset management commands in the first set are sorted in an order of receiving time, a time interval for receiving adjacent ones of the second dataset management commands in the first set is less than a predetermined time, and the memory controller is configured to:
begin to obtain the second logical address ranges in the second dataset management commands in response to:
receiving a third dataset management command within the predetermined time after receiving a last one of the second dataset management commands ; and
the third dataset management command including third identification information indicating the security delete operation is to be performed on third stored data corresponding to a third logical address range.

8. The memory system of claim 7, wherein the predetermined time ranges from two seconds to three seconds.

9. The memory system of claim 7, wherein the memory controller is configured to:
set a security deletion count to a first value in response to:
a fourth dataset management command is not received within the predetermined time after receiving a last one of the second dataset management commands in the first set; and
the fourth dataset management command to include fourth identification information indicating the security delete operation is to be performed on fourth stored data corresponding to a fourth logical address range.

10. The memory system of claim 9, wherein the memory controller is configured to:
update the security deletion count to a second value based on completion of third programming operations on third memory cells corresponding to the fifth physical addresses in the fifth set.

11. The memory system of claim 10, wherein the memory controller is configured to:
in response to a vendor-specific command, send a current value of the security deletion count.

12. The memory system of claim 7, wherein the memory controller is configured to:
aggregate fourth dataset management commands received within a time period to form a sixth set, the fourth dataset management commands including fourth identification information indicating the security delete operation is to be performed on fourth stored data corresponding to a fourth logical address range, wherein the time period is between receipt of a first one of the first, second, third, or fourth logical address ranges and completion of third programming operations on third memory cells corresponding to fifth physical addresses in the fifth set.

13. The memory system of claim 1, wherein the memory controller is configured to:
based on second identification information indicating that the security delete operation is not to be performed on second stored data corresponding to a second logical address range, unmap mapped relationships between logical addresses corresponding to the second logical address range and corresponding second physical addresses.

14. The memory system of claim 1, wherein the memory system comprises a solid-state drive or a memory card.

15. An electronic device, comprising:
a memory system, comprising:
a memory device; and
a memory controller coupled to the memory device and configured to:
receive a dataset management command, wherein the dataset management command includes a logical address range to be trimmed and identification information, the identification information is configured to indicate whether to perform a security delete operation on stored data corresponding to the logical address range;
based on the identification information indicating that the security delete operation is to be performed on the stored data corresponding to the logical address range, determine to perform a data overwrite operation on valid data in a stripe corresponding to the logical address range; and
determine to perform programming operations on memory cells corresponding to physical addresses of the stripe corresponding to the logical address range; and
a host coupled to the memory system.

16. A method comprising:
receiving a dataset management command, wherein the dataset management command includes a logical address range to be trimmed and identification information, the identification information is configured to indicate whether to perform a security delete operation on stored data corresponding to the logical address range;
based on the identification information indicating that the security delete operation is to be performed on the stored data corresponding to the logical address range, determining to perform a data overwrite operation on valid data in a stripe corresponding to the logical address range; and
determining to perform programming operations on memory cells corresponding to physical addresses of the stripe corresponding to the logical address range.

17. The method of claim 16, further comprising:
aggregating second dataset management commands to form a first set, the second dataset management commands including second identification information indicating that the security delete operation is to be performed on second stored data corresponding to second logical address ranges in the second dataset management commands;
based on the second identification information indicating that the security delete operation is to be performed on the second stored data corresponding to the second logical address ranges, determining to perform a second data overwrite operation on second valid data in a second stripe corresponding to the second logical address ranges; and
determining to perform second programming operations on second memory cells corresponding to second physical addresses of the second stripe corresponding to the second logical address ranges.

18. The method of claim 17, further comprising:
forming a second set based on the second logical address ranges in the second dataset management commands in the first set;
forming a third set based on logical addresses corresponding to the second logical address ranges in the second set;
determining third physical addresses corresponding to respective third logical addresses in the third set based on a table of mapped logical-to-physical address relationships to form a fourth set; and
determining fifth physical addresses of third stripes corresponding to respective ones of fourth physical addresses in the fourth set to form a fifth set.

19. The method of claim 18, wherein:
the determining to perform the data overwrite operation on the valid data in the stripe corresponding to the logical address range comprises determining to perform the data overwrite operation on the valid data at respective ones of the fifth physical addresses in the fifth set; and
the determining to perform the programming operations on the memory cells corresponding to the physical addresses of the stripe corresponding to the logical address range comprises determining to perform the programming operations on the memory cells corresponding to the fifth physical addresses in the fifth set.

20. The method of claim 18, further comprising:
after forming the fourth set, unmapping mapped relationships between respective fourth physical addresses in the fourth set and corresponding fourth logical address
